(19) United States
(12) Patent Application Publication
(10) Pub. No.: US 2025/0153345 A1
(43) Pub. Date: May 15, 2025

(54) SNAKE ROBOT AND MONOMERIC SEGMENT

(71) Applicant: Dongguan University of Technology, Dongguan City (CN)

(72) Inventors: Jialei SONG, Dongguan City (CN); Biao YANG, Dongguan City (CN); Ling YIN, Dongguan City (CN)

(21) Appl. No.: 18/894,426

(22) Filed: Sep. 24, 2024

(30) Foreign Application Priority Data
Nov. 10, 2023 (CN) 202311496328.2

(51) Int. Cl. B25J 9/06; B25J 9/10; B25J 13/08

(52) U.S. Cl. CPC B25J 9/065; B25J 9/102; B25J 13/086

(57) ABSTRACT

A snake robot and a monomeric segment thereof are provided. The monomeric segment includes a housing. One end of the housing is provided with a steering engine unit. A steering wheel of the steering engine unit protrudes out of the housing. The other end of the housing is provided with a connecting arm fitted with the steering engine unit of another steering engine unit. The portion, between the steering engine unit and the connecting arm, of the housing is provided with a traveling mechanism. The interior of the housing is provided with a driving unit in transmission connection with the traveling mechanism. In the same monomeric segment, a rotating axis of the steering wheel and a rotating axis of the connecting arm are perpendicular to each other.

### CROSS-REFERENCE TO RELATED APPLICATION

This patent application claims the benefit and priority of Chinese Patent Application No. 2023114963282 filed with the China National Intellectual Property Administration on Nov. 10, 2023, the disclosure of which is incorporated by reference herein in its entirety as part of the present application.

### TECHNICAL FIELD

The present disclosure relates to a snake robot, in particular to a snake robot and a monomeric segment.

### BACKGROUND

The snake robot has the characteristics of high ground adaptability, high stability, structural flexibility and so on. The snake robot can travel in all kinds of complex terrains, and has strong obstacle-crossing ability. At present, many snake robots with different structures have been studied all over the world, but most of the existing snake robots only realize two-dimensional motion. The fundamental reason is that the existing snake robot can only swing in a single direction through the driving structure arranged between adjacent joints.

In view of such situation, a monomeric segment is designed to solve the problem that the joints of the existing snake robot can only support the snake robot to move in the two-dimensional space, resulting in limited adaptability of the snake robot.

### SUMMARY

The present disclosure aims to provide a monomeric segment so as to solve the problems in the prior art. A rotating axis of a steering wheel and a rotating axis of a connecting arm in the same monomeric segment are arranged to be perpendicular to each other. A snake robot including the monomeric segments can swing left and right and also can swing up and down, and then the adaptive capacity of the snake robot on complex terrains is greatly improved.

In order to achieve the purpose, the present disclosure provides the following solutions.

The present disclosure provides a monomeric segment. The monomeric segment includes a housing. One end of the housing is provided with a steering engine unit, and a steering wheel of the steering engine unit protrudes out of the housing; an other end of the housing is provided with a connecting arm, the connecting arm is configured to fit with a steering engine unit in another monomeric segment, a portion between the steering engine unit and the connecting arm, of the housing is provided with a traveling mechanism, an interior of the housing is provided with a driving unit in transmission connection with the traveling mechanism; and a rotating axis of the steering wheel and a rotating axis of the connecting arm in a same monomeric segment are perpendicular to each other.

Preferably, the housing between the steering engine unit and the connecting arm is a middle housing, and each of two opposite surfaces of the middle housing is provided with the traveling mechanism.

Preferably, the traveling mechanism includes a driving motor and a reducer, the driving motor is in transmission connection with the reducer, the reducer is provided with two output shafts, a pair of worms with opposite rotating directions is separately mounted on the two output shafts, and the two worms are matched with worm gears respectively so that power of the driving motor is transmitted to the traveling mechanism located on each of the two opposite surfaces of the middle housing.

Preferably, the connecting arm includes two connecting plates protruding outwards, the two connecting plates are detachably connected with the housing, a groove fitted with the steering wheel is formed in one side, opposite to an other connecting plate, of any connecting plate of the two connecting plates, and the steering wheel is embedded into the groove and fixedly connected with a corresponding one of the two connecting plates.

Further, the present disclosure also provides a snake robot with the monomeric segments.

The snake robot includes a snake head, a snake tail and multiple monomeric segments arranged between the snake head and the snake tail, any one of the snake head and the snake tail is internally provided with a controller configured for controlling the whole snake robot to move and a power supply assembly for providing energy for the snake robot, and any two adjacent monomeric segments are connected with each other by fitting the steering engine unit with the connecting arm.

Preferably, one end of the snake head is provided with the connecting arm, and the snake head is fitted and connected with the steering engine unit of a downstream monomeric segment through the connecting arm of the snake head; and an other end of the snake head is provided with a detection assembly configured for detecting surroundings.

Preferably, the other end, away from the connecting arm, of the snake head is further provided with a protective cover configured for protecting the detection assembly, and the protective cover is connected with a shell of the snake head through a steering engine and connecting rod assembly so as to drive the protective cover to shield or open the detection assembly.

Preferably, one end of the snake tail is provided with the steering engine unit, the steering wheel of the steering engine unit of the snake tail protrudes out of a shell of the snake tail, and the snake tail is fitted and connected with the connecting arm of an upper stream monomeric segment through the steering engine unit of the snake tail.

Preferably, the snake robot also includes a first connecting module and a second connecting module which are arranged in a crossed shape, both ends of each of the first connecting module and the second connecting module are respectively provided with the connecting arm and the steering engine unit, and the first connecting module and the second connecting module are fitted and connected with the steering engine unit and the connecting arm of the multiple monomeric segments through the connecting arm and the steering engine unit; a convex structure is arranged between the connecting arm and the steering engine unit of the first connecting module, a concave structure fitted with the convex structure is arranged between the connecting arm and the steering engine unit of the second connecting module, and the first connecting module and the second connecting module are connected with each other by buckling the concave structure and the convex structure.

Preferably, the convex structure and the concave structure are separately provided with electromagnets.

Compared with the prior art, some embodiments have the following technical effects.

In the monomeric segment provided by the present disclosure, a rotating axis of the steering wheel and a rotating axis of the connecting arm are perpendicular to each other. That is, the monomeric segment can swing along a first direction with the rotating axis of the steering wheel as a swing center, and also can swing along a second direction perpendicular to the first direction with the rotating axis of the connecting arm as a swing center. And then, the snake robot with monomeric segments can swing left and right and also can swing up and down, so that the freedom degree of the snake robot is improved, the snake robot can move in a three-dimensional space, and then the technical effect of improving the adaptive capacity of the snake robot is realized. At the same time, according to the traveling mechanism arranged on the monomeric segment, the traveling mechanism at the position of any force point can provide forward moving power in the left-and-right swing or up-and-down swing process, so that the maneuverability of the snake robot is further enhanced.

### BRIEF DESCRIPTION OF THE DRAWINGS

In order to illustrate the embodiments of the present disclosure or the technical solutions in the prior art more clearly, the drawings needed in the embodiments will be briefly introduced hereinafter. Apparently, the drawings in the following description are only some embodiments of the present disclosure. For those skilled in the art, other drawings can be obtained according to these drawings without paying creative labor.

FIG. 1 is a structural schematic diagram of a monomeric segment.

FIG. 2 is a schematic diagram of a driving structure of a traveling mechanism.

FIG. 3 is a structural schematic diagram of a snake robot with monomeric segments.

FIG. 4 is a structural schematic diagram of a snake head.

FIG. 5 is a structural schematic diagram of a snake tail.

FIG. 6 is a structural schematic diagram of crossed connecting modules.

FIG. 7 is a structural schematic diagram of a first connecting module.

FIG. 8 is a structural schematic diagram of a second connecting module.

FIG. 9 is a structural schematic diagram of a crossed snake robot.

FIG. 10 is a structural schematic diagram of a crossed snake robot in the first embodiment.

FIG. 11 is a structural schematic diagram of a crossed snake robot in the second embodiment.

FIG. 12 is a structural schematic diagram of a crossed snake robot in the third embodiment.

FIG. 13 a structural schematic diagram of a crossed snake robot in the fourth embodiment.

FIG. 14 is a schematic diagram of a movement process in the fourth embodiment.

Reference signs: 1 housing; 2 steering wheel; 3 connecting arm; 4 traveling mechanism; 5 driving motor; 6 reducer; 7 worm; 8 worm gear; 9 groove; 10 snake head; 11 snake tail; 12 protective cover; 13 first connecting module; 14 second connecting module; 15 convex structure; and 16 concave structure.

### DETAILED DESCRIPTION OF THE EMBODIMENTS

The technical solutions in the embodiments of the present disclosure will be described clearly and completely hereinafter with reference to the drawings of the embodiments of the present disclosure. Apparently, the described embodiments are some embodiments of the present disclosure, rather than all of the embodiments. Based on the embodiments of the present disclosure, all other embodiments obtained by those skilled in the art without paying creative labor fall in the scope of protection of the present disclosure.

The present disclosure aims to provide a snake robot and a monomeric segment thereof so as to solve the problems in the prior art, so that the problem that the snake robot only realizes two-dimensional movement in the prior art is solved.

In order to make the above objects, features and advantages of the present disclosure more obvious and understandable, the present disclosure will be further explained in detail hereinafter with reference to the drawings and specific embodiments.

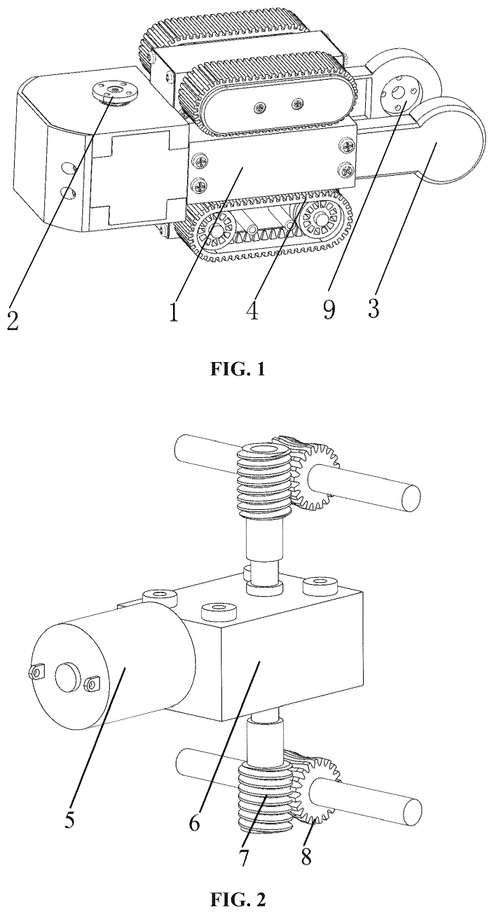

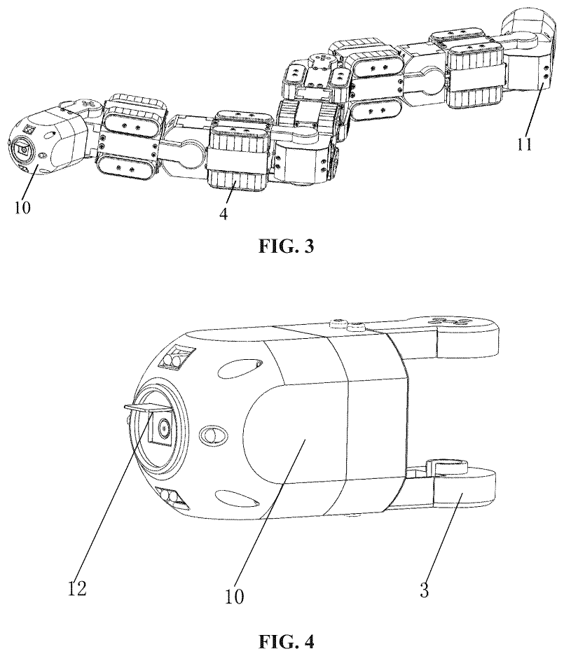

As shown in FIG. 1, the monomeric segment provided by the embodiment of the present disclosure includes a housing 1, a steering engine unit, a connecting arm 3 and a traveling mechanism 4, where the steering engine unit is arranged at one end of the housing 1, a steering wheel 2 of the steering engine unit protrudes out of the housing 1, and the connecting arm 3 is arranged at the other end of the housing 1. Mutual connection between the adjacent monomeric segments can be realized through the steering engine unit and the connecting arm 3. The portion, between the steering engine unit and the connecting arm 3, of the housing 1 is provided with the traveling mechanism 4. The interior of the housing 1 is provided with a driving unit in transmission connection with the traveling mechanism 4. The traveling of the monomeric segment can be realized through the cooperation of the driving unit and the traveling mechanism 4. At the same time, in the same monomeric segment, a rotating axis of the steering wheel 2 and a rotating axis of the connecting arm 3 are perpendicular to each other, so that the monomeric segment can swing along a first direction with the rotating axis of the steering wheel 2 as a swing center of the monomeric segment, and also can swing along a second direction perpendicular to the first direction with the rotating axis of the connecting arm 3 as a swing center of the monomeric segment. Thus, the snake robot with monomeric segments can swing left and right and also can swing up and down, so that the improvement on the freedom degree of the snake robot from two dimensions to three dimensions is realized, and the adaptive capacity of the snake robot is greatly improved.

Further, the steering engine and the traveling mechanism 4 can be controlled independently. On a relatively flat road surface, the snake robot can be driven to go forward and backward by the traveling mechanism 4. The steering function of the steering engine enables the snake robot to complete the movement in a prescribed direction, and the forward movement by the traveling mechanism 4 can enable the snake to obtain a faster movement speed, so that the movement efficiency is improved. On a relatively rugged road surface, the snake robot can creep forward through the cooperation of the steering engine and the traveling mechanism 4. The snake robot can simulate the forward creeping way of a real snake in nature by controlling the rotation of the steering engine at each joint. At the same time, the traveling mechanism on each joint of the body of the snake robot can provide power at different force points to move the snake body forward or backward under complex and rugged environments. Through the cooperation of the traveling mechanism and the steering engine, the snake robot can pass through more complex road surfaces.

As a preferable embodiment, as shown in FIG. 1, the housing 1 between the steering engine unit and the connecting arm 3 is substantially a structure of a cuboid shape or a crossed shape, so that after the traveling mechanism is arranged, the housing 1 between the steering engine unit and the connecting arm 3 is substantially a structure of a cuboid shape, and the traveling mechanism 4 is arranged on two opposite surfaces of the housing 1 between the steering engine unit and the connecting arm 3. When the monomeric segments are connected to each other to form the snake robot, it can be ensured that each of the upper, lower, left and right surfaces of the snake robot is provided with at least one group of traveling mechanisms 4. When the snake robot passes through some narrow spaces (such as tunnels and pipelines), the contact area between the snake body of the snake robot and the inside of the space can be increased by the traveling mechanisms 4 arranged in four directions, and then the driving force of the snake robot is improved.

As a preferable embodiment, as shown in FIG. 2, the traveling mechanism 4 includes a driving motor 5 and a reducer 6. The driving motor 5 is in transmission connection with the reducer 6. The reducer 6 is provided with two output shafts. A pair of worms 7 with opposite rotating directions is separately mounted on the two output shafts. The two worms 7 are matched with worm gears 8 respectively so that power of the driving motor 5 is transmitted to the traveling mechanism 4 located on two surfaces. Through the cooperation of the reducer 6 with double output shafts and the worm 7 and the worm gear 8, the same motor can simultaneously drive the traveling mechanisms 4 on both sides to travel, so that the complexity of the device is reduced.

Referring to FIG. 1 continuously, a crawler belt made of rubber is used as the traveling mechanism 4. The crawler belt has the characteristics of high stability, large load capacity, high anti-skid performance and low requirements on the road surfaces, so that the adaptability of the snake robot to complex road surfaces is further improved. A baffle is arranged on the outer side of the crawler belt to prevent the crawler belt from falling off. At the same time, unknown objects such as external stones and leaves are prevented from entering into the crawler belt to damage the structure at work.

Of course, those skilled in the art can understand that the traveling mechanism 4 may further be provided with structures with a traveling function such as wheels and belts, which is not particularly limited here.

As shown in FIG. 1, the connecting arm 3 includes two connecting plates protruding outwards. The connecting plate is detachably connected with the housing 1. A groove 9 fitted with the steering wheel 2 is formed in one side, opposite to the other connecting plate, of any connecting plate. The steering wheel 2 is embedded into the groove 9 and fixedly connected with the connecting plate, so that the fit and connection between the adjacent monomeric segments are completed.

Further, multiple first connecting holes are formed in the bottom of the groove 9 in a penetrating manner. Multiple second connecting holes adapted to the first connecting holes are formed in the steering wheel 2, and at least one of the first connecting hole and the second connecting hole is provided with an internal thread, and then fixed connection between the steering engine and the connecting arm 3 separately in the adjacent monomeric segments can be realized through bolted connection.

The embodiment of the present disclosure also provides a snake robot with the monomeric segments. The snake robot is an in-line snake. As shown in FIG. 1, the snake robot includes a snake head 10, a snake tail 11 and multiple monomeric segments arranged between the snake head and the snake tail. Any one of the snake head 10 and the snake tail 11 is internally provided with a controller and a power supply assembly. Any two adjacent monomeric segments are connected with each other by the fit and connection between the steering engine and the connecting arm 3. Where, each of the monomeric segment, the snake head 10 and the snake tail 11 is electrically connected with the power supply assembly which can provide energy for the snake robot. The controller can individually and/or simultaneously control any steering engine and any traveling mechanism 4 to realize the traveling and steering of the snake robot.

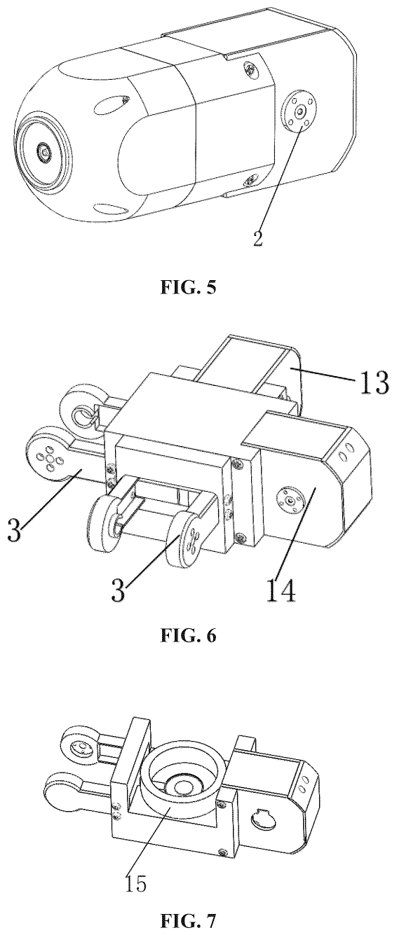

Preferably, as shown in FIG. 4, one end of the snake head 10 is provided with a connecting arm 3. The snake head 10 is fitted and connected with the steering engine of the lower stream monomeric segment through the connecting arm 3. The other end of the snake head 10 is provided with a detection assembly configured for detecting surroundings. The detection assembly includes a camera arranged at the central position of an end of the snake head 10, and an LED (Light Emitting Diode) lamp and an infrared detection assembly arranged on the periphery of the camera, so that the snake robot can accurately find a travelable route in a dark environment and collect the environmental information of surroundings, that is, the normal operation of the snake robot in a dark environment is realized. More preferably, the snake head 10 is further provided with a protective cover 12 configured for protecting the detection assembly at a camera end. The protective cover 12 is connected with the housing through a steering engine and connecting rod assembly. The steering engine and connecting rod assembly can drive the protective cover 12 to carry out opening and closing movement, and then the detection assembly is shielded or opened. The detection assembly is closed to be protected when not needed, and dust and mud falling above can also be shielded when the protective cover 12 is opened, so that the detection assembly is prevented from being shielded by stains.

Referring to FIG. 5, one end of the snake tail 11 is provided with a steering engine. A steering wheel 2 of the steering engine protrudes out of the housing 1 of the snake tail 11. The snake tail 11 is in fitted and connected with the connecting arm 3 of an upper stream monomeric segment through the steering engine.

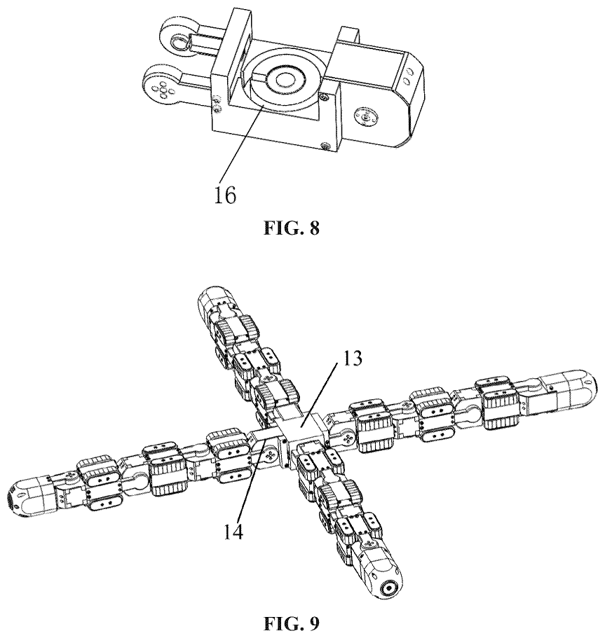

Further, as shown in FIG. 6 to FIG. 8, the snake robot also includes a first connecting module 13 and a second connecting module 14 which are arranged in a crossed shape. Both ends of each of the first connecting module 13 and the second connecting module 14 are respectively provided with the connecting arm 3 and the steering engine. The first connecting module 13 and the second connecting module 14 are in fitted and connected with the steering engine and the connecting arm 3 in the monomeric segment through the connecting arm 3 and the steering engine so as to form an in-line snake robot with the connecting modules. A convex structure 15 is arranged between the connecting arm 3 of the first connecting module 13 and the steering engine. A concave structure 16 fitted with the convex structure 15 is arranged between the connecting arm 3 of the second connecting module 14 and the steering engine. The first connecting module 13 and the second connecting module 14 are connected with each other by buckling the concave structure 16 and the convex structure 15, and then two in-line snake robots can be connected into a crossed snake robot.

As shown in FIG. 9, the embodiment discloses a crossed snake robot. The crossed snake robot includes two same in-line snake robots. Each of the two in-line snake robots includes six monomeric segments and one of the first connecting module 13 and the second connecting module 14, where both sides of the first connecting module 13 and the second connecting module 14 are respectively connected with three monomeric segments. Compared with a single in-line snake robot, the crossed snake robot has a more complex movement mode.

### Embodiment I

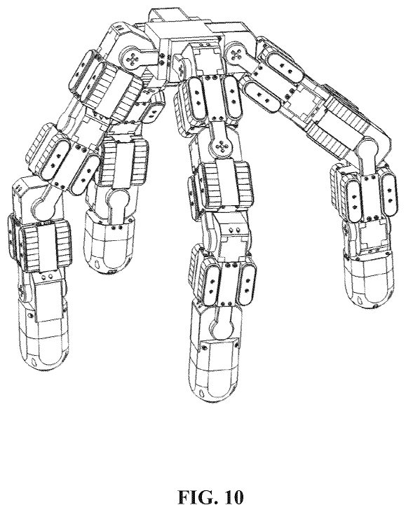

As shown in FIG. 10, the crossed snake robot can become a quadruped robot traveling upright by controlling the steering engines. Two snake heads 10 and two snake tails 11 are in contact with the ground respectively. Each foot includes four joints which can rotate by 180° in different planes. By controlling the rotating angle of the steering engines on each of the feet and the cooperation between the steering engines, the snake robot can travel upright on four feet. Because the four feet have the characteristics of long length and small contact area with the ground, the traveling mode is suitable for roads with more obstacles but relatively hard texture.

Further, one end, close to the ground, of the snake head and the snake tail is also provided with a circular rubber ring. The impact on the snake head and/or the snake tail can be alleviated when the snake head and/or the snake tail are/is in contact with the ground or the wall. At the same time, the snake head and/or the snake tail have/has an anti-slip effect.

Those skilled in the art can understand that the crossed connecting modules and the monomeric segments can be arbitrarily arranged and combined according to actual needs.

### Embodiment II

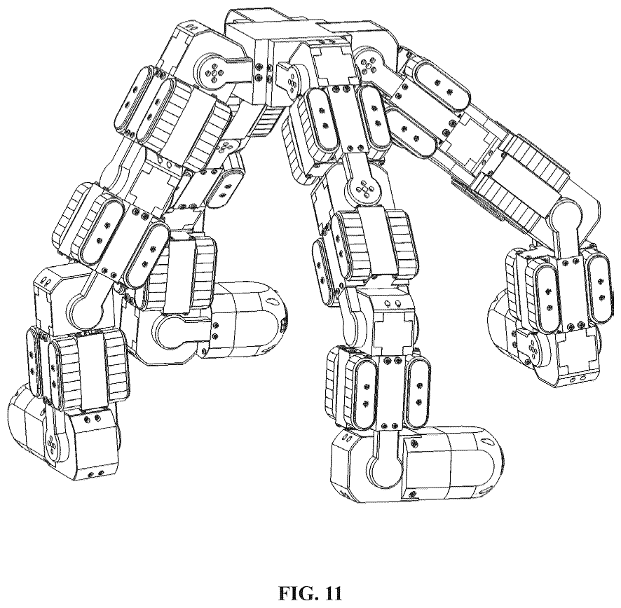

As shown in FIG. 11, each snake head 10 and each snake tail 11 rotate by 90° on the basis of FIG. 10 respectively by controlling the steering engines connected with the snake head 10 and the snake tail 11 so as to form a mechanical foot similar to a human foot, so that the contact area between the whole crossed snake robot and the ground is increased. Because of the characteristic of large contact area with the road surface, this traveling mode is suitable for soft road surfaces, and the principle that the larger the contact area is, the smaller the pressure is, so that the machine is less likely to fall into the soft substrates.

### Embodiment III

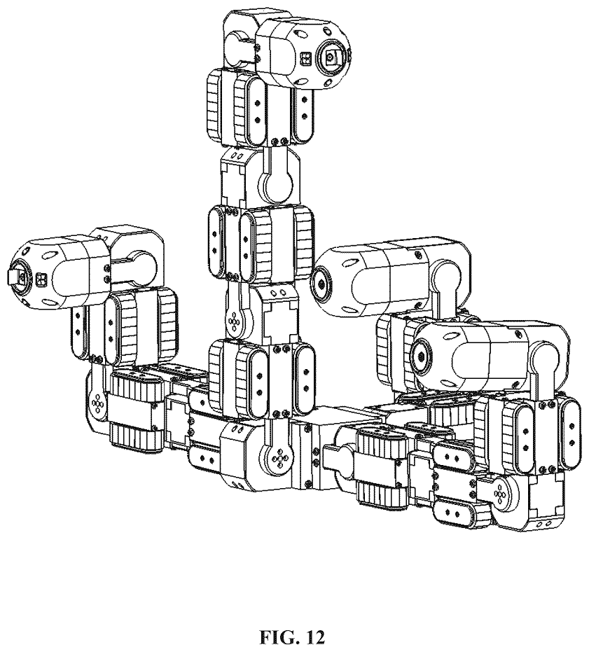

As shown in FIG. 12, such posture can be made by controlling the steering of the steering engines. The contact area of the snake robot with the ground is further increased, so the snake robot is higher in stability. Under such posture, some of the crawler belts are in contact with the ground and parallel to each other, so the whole machine can be driven to move through the crawler belts. At the same time, because of the characteristics of gravity center stability and rotatable joints of the snake robot, such posture is suitable for cases requiring long-term observation, and the observable range can be expanded by controlling the rotation of the joints and the rotation of the snake head 10 through the steering engines.

### Embodiment IV

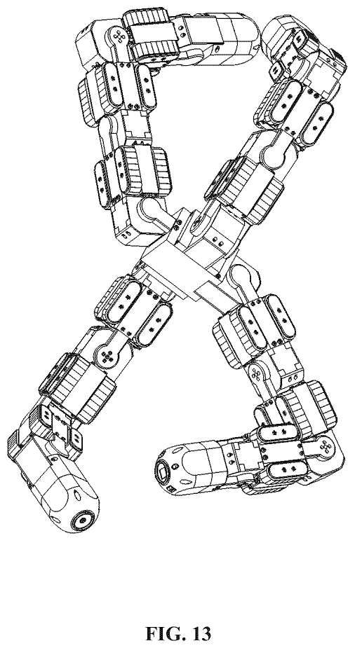

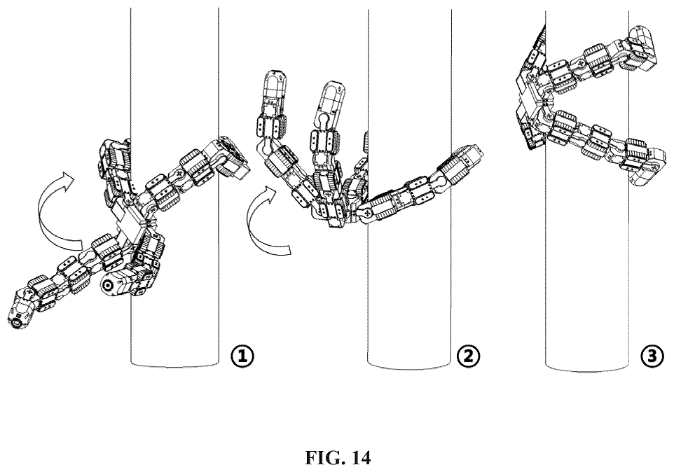

As shown in FIG. 13, the two adjacent feet are formed to be a hugging posture by controlling the steering engines. A tree is hugged by the two upper feet, and then the two lower feet are overturned to be in a hugged posture as well to hug the tree through the rotation of the steering engines at the joints. The crawler belts made of rubber can play an anti-skid role in the process. Then, a tree climbing function of the machine can be realized, so that the action and observation range of the machine is not limited to road surfaces. FIG. 14 illustrates a tree climbing movement mode of the snake robot.

In this specification, specific embodiments aim to illustrate the principle and implementation of the present disclosure. The explanation of the above embodiments is only used to help understand the method and its core idea of the present disclosure. According to the idea of the present disclosure, there will be some changes in the specific implementation and application scope for those skilled in the art. To sum up, the contents of this specification should not be construed as limiting the present disclosure.

What is claimed is:

1. A monomeric segment, comprising
a housing having one end provided with a steering engine unit, a steering wheel of the steering engine unit protrudes out of the housing;
an other end of the housing is provided with a connecting arm configured to fit with a steering engine unit in another monomeric segment, a portion of the housing between the steering engine unit and the connecting arm is provided with a traveling mechanism, an interior of the housing is provided with a driving unit in transmission connection with the traveling mechanism; and
a rotating axis of the steering wheel and a rotating axis of the connecting arm in a same monomeric segment are perpendicular to each other.

2. The monomeric segment according to claim 1, wherein the portion of the housing between the steering engine unit and the connecting arm is a middle housing, and each of two opposite surfaces of the middle housing is provided with the traveling mechanism.

3. The monomeric segment according to claim 2, wherein the traveling mechanism comprises:
a driving motor and a reducer, the driving moto is in transmission connection with the reducer, the reducer is provided with two output shafts, a pair of worms with opposite rotating directions is separately mounted on the two output shafts, and the pair of worms are matched with worm gears respectively so that power of the driving motor is transmitted to the traveling mechanism located on each of the two opposite surfaces of the middle housing.

4. The monomeric segment according to claim 1, wherein the connecting arm comprises two connecting plates protruding outwards, the two connecting plates are detachably connected with the housing, a groove fitted with the steering wheel is formed in one side, opposite to an other connecting plate, of any connecting plate of the two connecting plates, and the steering wheel is embedded into the groove and fixedly connected with a corresponding one of the two connecting plates.

5. A snake robot with the monomeric segment according to claim 1, wherein the snake robot comprises a snake head, a snake tail and a plurality of monomeric segments arranged between the snake head and the snake tail, any one of the snake head and the snake tail is internally provided with a controller for controlling the whole snake robot to move and a power supply assembly for providing energy for the snake robot, and any two adjacent monomeric segments are connected with each other by fitting the steering engine unit with the connecting arm.

6. The snake robot according to claim 5, wherein one end of the snake head is provided with the connecting arm, and the snake head is fitted and connected with the steering engine unit of a downstream monomeric segment through the connecting arm of the snake head; and an other end of the snake head is provided with a detection assembly configured for detecting surroundings.

7. The snake robot according to claim 6, wherein the other end, away from the connecting arm, of the snake head is further provided with a protective cover to protect the detection assembly, and the protective cover is connected with a shell of the snake head through a further steering engine and connecting rod assembly so as to drive the protective cover to shield or open the detection assembly.

8. The snake robot according to claim 5, wherein one end of the snake tail is provided with the steering engine unit, the steering wheel of the steering engine unit of the snake tail protrudes out of a shell of the snake tail, and the snake tail is fitted and connected with the connecting arm of an upper stream monomeric segment through the steering engine unit of the snake tail.

9. The snake robot according to claim 5, further comprising a first connecting module and a second connecting module arranged in a crossed shape, both ends of each of the first connecting module and the second connecting module are respectively provided with the connecting arm and the steering engine unit, and the first connecting module and the second connecting module are fitted and connected with the steering engine unit and the connecting arm of the plurality of monomeric segments through the connecting arm and the steering engine unit; a convex structure is arranged between the connecting arm and the steering engine unit of the first connecting module, a concave structure fitted with the convex structure is arranged between the connecting arm and the steering engine unit of the second connecting module, and the first connecting module and the second connecting module are connected with each other by buckling the concave structure and the convex structure.

10. The snake robot according to claim 9, wherein the convex structure and the concave structure are separately provided with electromagnets.

11. A snake robot with the monomeric segment according to claim 2, wherein the snake robot comprises a snake head, a snake tail and a plurality of monomeric segments arranged between the snake head and the snake tail, any one of the snake head and the snake tail is internally provided with a controller configured for controlling the whole snake robot to move and a power supply assembly for providing energy for the snake robot, and any two adjacent monomeric segments are connected with each other by fitting the steering engine unit with the connecting arm.

12. A snake robot with the monomeric segment according to claim 3, wherein the snake robot comprises a snake head, a snake tail and a plurality of monomeric segments arranged between the snake head and the snake tail, any one of the snake head and the snake tail is internally provided with a controller configured for controlling the whole snake robot to move and a power supply assembly for providing energy for the snake robot, and any two adjacent monomeric segments are connected with each other by fitting the steering engine unit with the connecting arm.

13. A snake robot with the monomeric segment according to claim 4, wherein the snake robot comprises a snake head, a snake tail and a plurality of monomeric segments arranged between the snake head and the snake tail, any one of the snake head and the snake tail is internally provided with a controller configured for controlling the whole snake robot to move and a power supply assembly for providing energy for the snake robot, and any two adjacent monomeric segments are connected with each other by fitting the steering engine unit with the connecting arm.

14. The snake robot according to claim 11, wherein one end of the snake head is provided with the connecting arm, and the snake head is fitted and connected with the steering engine unit of a downstream monomeric segment through the connecting arm of the snake head; and an other end of the snake head is provided with a detection assembly configured for detecting surroundings.

15. The snake robot according to claim 12, wherein one end of the snake head is provided with the connecting arm, and the snake head is fitted and connected with the steering engine unit of a downstream monomeric segment through the connecting arm of the snake head; and an other end of the snake head is provided with a detection assembly configured for detecting surroundings.

16. The snake robot according to claim 13, wherein one end of the snake head is provided with the connecting arm, and the snake head is fitted and connected with the steering engine unit of a downstream monomeric segment through the connecting arm of the snake head; and an other end of the snake head is provided with a detection assembly configured for detecting surroundings.

17. The snake robot according to claim 14, wherein the other end, away from the connecting arm, of the snake head is further provided with a protective cover configured for protecting the detection assembly, and the protective cover is connected with a shell of the snake head through a steering engine and connecting rod assembly so as to drive the protective cover to shield or open the detection assembly.

18. The snake robot according to claim 15, wherein the other end of the snake head, away from the connecting arm is further provided with a protective cover to protect the detection assembly, and the protective cover is connected with a shell of the snake head through a steering engine and connecting rod assembly so as to drive the protective cover to shield or open the detection assembly.

19. The snake robot according to claim 16, wherein the other end of the snake head, away from the connecting arm is further provided with a protective cover to protect the detection assembly, and the protective cover is connected with a shell of the snake head through a steering engine and connecting rod assembly so as to drive the protective cover to shield or open the detection assembly.

20. The snake robot according to claim 11, wherein one end of the snake tail is provided with the steering engine unit, the steering wheel of the steering engine unit of the snake tail protrudes out of a shell of the snake tail, and the snake tail is fitted and connected with the connecting arm of an upper stream monomeric segment through the steering engine unit of the snake tail.
